(19) United States
(12) Patent Application Publication
(10) Pub. No.: US 2019/0308398 A1
(43) Pub. Date: Oct. 10, 2019

(54) SELF-HEALING SURFACE PROTECTIVE FILM WITH AN ACRYLATE-FUNCTIONAL TOPCOAT

(71) Applicant: TESA SE, Norderstedt (DE)

(72) Inventors: Monika JUNGHANS, Hamburg (DE); Klaus KEITE-TELGENBÜSCHER, Hamburg (DE)

(73) Assignee: TESA SE, Norderstedt (DE)

(21) Appl. No.: 16/315,339

(22) PCT Filed: Jul. 3, 2017
(86) PCT No.: PCT/EP2017/000783

§ 371 Date: Jan. 4, 2019

(30) Foreign Application Priority Data
Jul. 4, 2016 (DE) 10 2016 212 106.5

(51) Int. Cl. B32B 27/40; B29D 11/00; C08G 18/42; C08G 18/78; C09J 7/29

(52) U.S. Cl. CPC B32B 27/40; B29D 11/00865; C08G 18/4277; C08G 18/7837; B05D 3/061; B32B 2605/006; B32B 2305/72; B32B 2307/554; C09J 7/29

(57) ABSTRACT

Disclosed is a composite film comprising a coating layer, a polymer film layer, and an adhesive layer, the coating layer being joined to one major surface of the polymer film layer, and the adhesive layer being joined to the opposite major surface of the polymer film layer, in such a way that the polymer film layer is embedded between the coating layer and the adhesive layer. Self-healing properties of the coating and elastic properties of the film act synergistically in such a way that the protective film exhibits a wear resistance which is achieved by neither coating nor film alone.

The invention relates to a composite film, more particularly a surface protection film, comprising at least a coating layer, a polymer film layer, and an adhesive layer, the coating layer being joined to one major surface of the polymer film layer, and the adhesive layer being joined to the opposite major surface of the polymer film layer, in such a way that the polymer film layer is embedded between the coating layer and the adhesive layer, and also to the use of this composite film.

Surface protection films, especially in the automotive sector, are often of multilayer construction in order, for example, to give the surface a greater gloss or an improved abrasion resistance.

Known in particular are multilayer surface protection films having a carrier film composed of one polyurethane and having an outer layer composed of a further polyurethane. For example, EP 1 874 541 B1 describes the production of the outer layer from an aqueous or solvent-based polyurethane. This polyurethane is crosslinked with crosslinkers such as aziridine or isocyanate. A problem in that case is that aziridine and isocyanate are substances which are harmful to health.

Also known in the prior art are surface protection films having a carrier film and an outer layer composed of a radiation-crosslinkable coating material, more particularly a radiation-crosslinkable coating material based on polyfunctional (meth)acrylates, such as urethane acrylates, for example.

An overview of the technology of the radiation-curable coating materials and diverse possibilities for use can be acquired by studying reviews, which can be found for example in Dowbenko and coworkers [R. Dowbenko, C. Friedlander, G. Gruber, P. Prucnal, M. Wismer, Progr. Org. Coat., 1983, 11, 71], in Holman and Oldring [R. Holman, P. Oldring (eds.), UV and EB Curing Formulations for Printing Inks, Coatings and Paints, 2nd edn., 1988, SITA Technology, London], in a multivolume work by Oldring [P. Oldring (eds.), Chemistry & Technology of UV & EB Formulations for Coatings, Inks & Paints, 1991, SITA Technology, London] or in C. Decker [C. Decker in Materials Science and Technology, R. W. Cahn, P. Hansen, E. J. Kramer (eds.), volume 18, 1997, Wiley-VCH, Weinheim].

Such surface protection films are subject matter for example of DE 10 2006 002 595 A1 and of DE 10 2006 002 596 A1.

There are also a range of further publications describing radiation-curable coating formulations which are employed for the coating of polymeric films. These formulations typically share the feature that at least one kind of polyfunctional (meth)acrylate is present in the formula. By exposure to suitable radiation, initiated by photoinitiators in the case of UV curing, these (meth)acrylated monomers, oligomers or polymers are excited to polymerization, thus producing a close-meshed network. The formulas may comprise diverse further kinds of constituents. In particular, inorganic particles have been described as being usable advantageously in respect of greater coating hardnesses. Examples of radiation-curable coating formulations can be found in U.S. Pat. No. 4,557,980 to Martin Processing Inc., in U.S. Pat. No. 4,319,811 A to GAF Corp., in EP 0 050 996 B1 to Mitsui Petrochemical, in U.S. Pat. No. 4,310,600 A to American Hoechst Corp., in JP 01 266 155 A to Sunstar, and in U.S. Pat. No. 5,104,929 A to 3M.

There are nowadays various products in film form known that according to the description have been or can be provided with protective coatings. The function of the protective coating is to make the actual film material, or further functional layers located thereon, more resistant toward external influences. Examples are disclosed in U.S. Pat. No. 6,440,551 A by CP Films and in U.S. Pat. No. 6,329,041 A and 6,638,606 A by Dai Nippon Printing, and also in DE 10 2004 046 767 A by CKT Folientechnik.

Furthermore, WO 92/22619 A1 discloses a surface protection film in the form of an adherable film which can be used as a protective layer in open-air applications. The film comprises an adhesive layer, a polymer film, and a transparent coating. The adhesive composition is preferably a pressure-sensitive adhesive which is tacky at room temperature. The polymer film consists preferably of a polyurethane elastomer and may be transparent or comprise dyes. Furthermore, the adherable film may comprise an aliphatic polyurethane material. The transparent coating consists of a transparent polyurethane composition. This also encompasses polyurethane acrylates, especially those based on polyether.

DE 10 2006 002 595 A1 discloses surface protection films equipped with radiation-curing outer layers of these kinds. Such coating formulations to be coated and cured may comprise at least one kind of inorganic oxides in particulate form. The surface of these particles is functionalized in such a way that the particles not only form a stable suspension in the organic matrix formed by the coating resin mixture, but can also be chemically linked to the organic network as it forms during the curing process. It is particularly advantageous if such surface functionalization is accomplished by reaction of the particles with coupling reagents such as, in particular, unsaturated silanes or titanates. In this regard, see, for example, L. N. Lewis, D. Katsamberis, J. Appl. Polym. Sci., 1991, 42, 1551, EP 1 366 112 B1 to Hansechemie or U.S. Pat. No. 6,136,912 A to Clariant S A. Such formulations may comprise amorphous silicas or corundum, with average particle diameter of typically below 100 nm. Particle contents are situated for example at up to 50 wt % or at up to 30 wt %.

One advantage of radiation-curable coating formulations is that no solvent at all need be used.

Nanoparticle-containing coating formulas which additionally contain other, highly specific constituents are described in JP 01 266 155 A by Sunstar and in U.S. Pat. No. 5,104,929 A by 3M, including for use on film substrates. EP 2 782 755 B1 (3M) describes such formulas in a polyurethane binder for surface protection films based on thermoplastic polyurethane.

Protective coatings composed of flexible, soft polymeric compositions, known as “self-healing” compositions, which are applied, for example, in the form of two-component coatings composed of polyurethane, with three-dimensional crosslinking, are common knowledge.

The soft coating materials themselves must be applied in relatively thick layers in order to ensure a protective effect with respect to gravel particles, as required for example in exterior applications on automobiles. The thicknesses of the layers of soft coating material are generally above 25 μm and may reach 40 μm.

Self-healing properties have already been shown in formulations for automotive refinish materials, for OEM clearcoats, and for plastics clearcoats. More recently, self-healing coatings have also been tested in furniture surfaces.

In the prior art, urethane structures and urea structures in an elastic polyurethane coating material are regarded as necessary prerequisites for the self-healing effect.

Self-healing surface protection films with polyurethane protective coating material are known under the name Cosmotac SR from Cosmotec (Japan).

Self-healing coating materials based on acrylates are known from DE 696 15 819 T2. They are prepared from high molecular mass polyurethane acrylates which are solid at room temperature and can be processed only in the form of a solvent-containing coating formulation.

It has been ascertained that these very flexible protective coatings have the disadvantage that they are comparatively not very smooth and for that reason hold the dirt which is deposited on them, thereby causing acceleration to the surface breakdown of the protective layer in the course of service.

The problem was to provide an improved surface protection film which avoids the disadvantages of the prior art. The film more particularly is to have self-healing properties, and the production of the film is to require ingredients, such as crosslinker or solvent, which are comparatively not very hazardous, and to avoid the use of heat input during production.

The problem stated above is solved in accordance with the invention by a composite film of the type specified at the outset, in which
the coating layer is an acrylate coating layer produced from a coating formulation which comprises at least one compound which contains at least two (meth)acrylate functions;
the coating layer at room temperature has a surface hardness (HM 0.300/20.0/5.0) of 2.0 to 3.5 N/mm², preferably of 2.0 to 3 N/mm², more particularly of 2.0 to 2.5 N/mm²; and
the polymer film layer at room temperature has a surface hardness (HM 0.300/20.0/5.0) of 2.0 to 4.0 N/mm², preferably of 2.0 to 3 N/mm², more particularly of 2.0 to 2.5 N/mm², and an elastic recovery after the surface hardness measurement with a release rate of 300 nN/20 s of more than 75%.

The concept on which the solution to the problem is based is that of providing an improved, more particularly self-healing, surface protection film by combining a carrier film of selected hardness and elasticity with a surface protection coating having specific viscoelastic properties in conjunction with high wear resistance. The elastic properties of the film act synergistically with the self-healing properties of the coating, and lead, surprisingly, to a wear resistance on the part of the protective film that is achieved by neither coating nor film alone.

This coating is composed of specific, acrylate-functional resins, and preferably comprises nanoparticles. These coating formulations are isocyanate-free and can be formulated to the balanced profile of properties required for surface protection films, in respect of stretchability and hardness. Furthermore, they exhibit good weathering stability. This coating layer of the invention is referred to below as acrylate coating layer.

Surprisingly it has emerged that identical coatings of the invention applied to harder polymer films no longer had any self-healing properties and were less bend-resistant. Even when the coating of the invention is applied to a softer film having less than the required elastic recovery, the coating loses its self-healing properties and, moreover, the surface protection film becomes less abrasion-resistant. If the coating itself is softer and has a hardness lower than the hardness of the invention, the surface protection film coated with this coating loses abrasion resistance.

The coating layer provided in accordance with the invention is obtained preferably by curing of radiation-curable formulations. Coating formulations of the invention comprise at least one compound containing at least two (meth)acrylate functions. Using further compounds with a higher number of (meth)acrylate functionalities is less advantageous in the context of this invention.

The term “(meth)acrylate” here encompasses all compounds which carry methacrylate, acrylate functions or both.

Compounds used which carry at least two (meth)acrylate functions are compounds, for example, from the list encompassing difunctional aliphatic (meth)acrylates such as 1,4-butanediol di(meth)acrylate, 1,6-hexanediol di(meth)acrylate, dipropylene glycol di(meth)acrylate, tricyclodecanedimethylol di(meth)acrylate, trifunctional aliphatic (meth)acrylates such as trimethylolpropane tri(meth)acrylate, tetrafunctional aliphatic (meth)acrylates such as ditrimethylolpropane tetra(meth)acrylate, pentafunctional aliphatic (meth)acrylates such as dipentaerythritol monohydroxypenta(meth)acrylate, hexafunctional aliphatic (meth)acrylates such as dipentaerythritol hexa(meth)acrylate. It is possible, further, for aliphatic or aromatic, especially ethoxylated and propoxylated, polyether (meth)acrylates having, in particular, two, three, four or six (meth)acrylate functions such as ethoxylated bisphenol A di(meth)acrylate, polyethylene glycol di(meth)acrylate, propoxylated trimethylolpropane tri(meth)acrylate, propoxylated glycerol tri(meth)acrylate, propoxylated neopentylglycerol di(meth)acrylate, ethoxylated trimethylolpropane di(meth)acrylate, ethoxylated trimethylolpropane tri(meth)acrylate, tetraethylene glycol di(meth)acrylate, ethoxylated neopentyl glycol di(meth)acrylate, propoxylated pentaerythritol tri(meth)acrylate, dipropylene glycol di(meth)acrylate, ethoxylated trimethylolpropane methyl ether di(meth)acrylate, aliphatic or aromatic polyester (meth)acrylates having, in particular, two, three, four or six (meth)acrylate functions, aliphatic or aromatic urethane (meth)acrylates having, in particular, two, three, four or six (meth)acrylate functions, aliphatic or aromatic epoxy (meth)acrylates having, in particular, two, three, four or six (meth)acrylate functions to be used in accordance with the invention. Furthermore, polyunsaturated vinyl ethers may advantageously be employed.

Preference is given to aliphatic urethane (meth)acrylates, especially those having two (meth)acrylate functions, because they are weathering-stable and yellowing-stable and their use supports the self-healing properties. Especially preferred is a polyester polyurethane (meth)acrylate.

The compound carrying at least two (meth)acrylate functions preferably has a number-average molecular weight Mₙ of more than 1000 g/mol, more preferably of more than 2000 g/mol. By this means a sufficient elasticity of the layer is advantageously produced.

With further preference the compound carrying at least two (meth)acrylate functions has a number-average molecular weight Mₙ of less than 5000 g/mol, more preferably of less than 3000 g/mol. By this means, advantageously, sufficient scratch resistance of the coating is achieved.

Preferred minimum and maximum limits to the molecular weight may advantageously also be combined arbitrarily.

The compound carrying at least two (meth)acrylate functions is preferably in liquid phase at 23° C. That allows solvent-free coating formulations to be produced.

The compound carrying at least two (meth)acrylate functions is preferably present in the coating formulation at a weight fraction of more than 30% of the total amount of compounds carrying acrylate or vinyl functions, more preferably at more than 45 wt %.

Aliphatic urethane (meth)acrylate is preferably present in the coating formulation at a weight fraction of more than 36 wt %, more preferably at more than 45 wt %.

The formulation from which the acrylate coating layer is produced preferably comprises at least one compound containing at least two (meth)acrylate functions, and at least one further compound containing one (meth)acrylate function.

The coating formulation preferably comprises as compound exclusively monomers, at least one of the monomers being polyfunctional, preference being given to difunctional monomers. Optionally, moreover, there may be further monomers present which are only monofunctional.

Where compounds are employed which carry one (meth)acrylate function, use is made for the purposes of this invention, for example, of (meth)acrylate monomers, more particularly those which conform to the general structural formula (I).

CH₂═C(R1)(COOR2) (I)

where R1 is H or CH₃ and R2 is H or linear, branched or cyclic, saturated or unsaturated alkyl radicals having 1 to 30 carbon atoms.

Monomers which can be used in the sense of the general structure (I) comprise acrylic and methacrylic esters with alkyl groups consisting of 4 to 18 carbon atoms. Specific examples of corresponding compounds, without wishing this enumeration to impose any restriction, are n-butyl acrylate, n-pentyl acrylate, n-hexyl acrylate, n-heptyl acrylate, n-octyl acrylate, n-nonyl acrylate, lauryl acrylate, hexadecyl acrylate, stearyl acrylate, stearyl methacrylate, behenyl acrylate and branched isomers thereof, such as, for example, 2-ethylhexyl acrylate, isooctyl acrylate, isodecyl acrylate, and tridecyl acrylate, and also cyclic monomers such as, for example, cyclohexyl acrylate, tetrahydrofurfuryl acrylate, dihydrodicyclopentadienyl acrylate, 4-tert-butylcyclohexyl acrylate, norbornyl acrylate, and isobornyl acrylate. Likewise employable as monomers are acrylic and methacrylic esters which contain aromatic 9/16 radicals, such as, for example, phenyl acrylate, benzyl acrylate, phenyl methacrylate, benzyl methacrylate, phenoxyethyl acrylate, ethoxylated phenol acrylate or ethoxylated nonylphenol acrylate.

Further monomers which can be used in accordance with the invention are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxybutyl methacrylate, 4-hydroxybutyl acrylate, acryloylmorpholine, methacryloylmorpholine, trimethylolpropane formal monoacrylate, propoxylated neopentyl methyl ether monoacrylate, tripropylene glycol methyl ether monoacrylate, ethoxylated ethyl acrylate such as ethyl diglycol acrylate, propoxylated propyl acrylate, acrylic acid, methacrylic acid, itaconic acid and esters thereof, crotonic acid and esters thereof, maleic acid and esters thereof, fumaric acid and esters thereof, maleic anhydride, methacrylamide and also N-alkylated derivatives such as N-methylolmethacrylamide, acrylamide and also N-alkylated derivatives such as N-methylolacrylamide, vinyl alcohol, 2-hydroxyethyl vinyl ether, 3-hydroxypropyl vinyl ether, and 4-hydroxybutyl vinyl ether.

It is possible, moreover, to use aliphatic or aromatic, especially ethoxylated or propoxylated, polyether mono(meth)acrylates, aliphatic or aromatic polyester mono(meth)acrylates, aliphatic or aromatic urethane mono(meth)acrylates or aliphatic or aromatic epoxy mono(meth)acrylates as compounds which carry one (meth)acrylate function.

Having emerged as being particularly suitable are compounds which have one morpholine group and one vinyl group, especially those which have one morpholine group and one 1-oxopropenyl group.

Preference is given to using 4-(1-oxo-2-propenyl)morpholine (compound II), since in this way it is possible for the viscoelastic properties of the first layer to be set outstandingly. The compound is included in the coating base preferably at a fraction of 10 to 50 wt %. More particularly the weight fraction is more than 25 wt %.

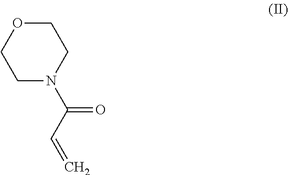

Moreover, for the formulation of which the coating layer consists, vinyl monomers from the following groups may be used: vinyl esters, vinyl ethers, vinyl halides, vinylidene halides, and also vinyl compounds containing aromatic ring systems or heterocycles in α-position. For the vinyl monomers which can optionally be employed, selected monomers useful in accordance with the invention may be given by way of example: vinyl acetate, vinylcaprolactam, vinylformamide, vinylpyridine, ethyl vinyl ether, 2-ethylhexyl vinyl ether, butyl vinyl ether, vinyl chloride, vinylidene chloride, acrylonitrile, styrene, and α-methylstyrene.

Where those interpretations of this invention in which the coating formulation, after coating has taken place, is cured by electromagnetic radiation, and more particularly here by UV radiation, are employed, the coating formulation is admixed with at least one kind of photoinitiator.

Suitable representatives of such photoinitiators are type I photoinitiators, in other words those known as α-splitters such as benzoin derivatives and acetophenone derivatives, benzil ketals or acylphosphine oxides, type II photoinitiators, in other words those known as hydrogen abstractors such as benzophenone derivatives and certain quinones, diketones, and thioxanthones. It is possible, furthermore, for triazine derivatives to be used in order to initiate radical reactions.

Type I photoinitiators which can be used advantageously comprise, for example, benzoin, benzoin ethers such as, for example, benzoin methyl ether, benzoin isopropyl ether, benzoin butyl ether, benzoin isobutyl ether, methylolbenzoin derivatives such as methylolbenzoin propyl ether, 4-benzoyl-1,3-dioxolane and its derivatives, benzil ketal derivatives such as 2,2-dimethoxy-2-phenylacetophenone or 2-benzoyl-2-phenyl-1,3-dioxolane, α,α-dialkoxyacetophenones such as α,α-dimethoxyacetophenone and α,α-diethoxyacetophenone, α-hydroxyalkylphenones such as 1-hydroxycyclohexyl phenyl ketone, 2-hydroxy-2-methyl-1-phenylpropanone, and 2-hydroxy-2-methyl-1-(4-isopropylphenyl)propanone, 4-(2-hydroxyethoxy)phenyl-2-hydroxy-2-methyl-2-propanone and its derivatives, α-aminoalkylphenones such as 2-methyl-1-[4-(methylthio)phenyl]-2-morpholinopropan-2-one and 2-benzyl-2-dimethylamino-1-(4-morpholinophenyl)butan-1-one, acylphosphine oxides such as 2,4,6-trimethylbenzoyldiphenylphosphine oxide and ethyl 2,4,6-trimethylbenzoylphenylphosphinate, and O-acyl-α-oximino ketones.

Type II photoinitiators which can be used advantageously comprise, for example, benzophenone and its derivatives such as 2,4,6-trimethylbenzophenone or 4,4′-bis(dimethylamino)benzophenone, thioxanthone and its derivatives such as 2-isopropylthioxanthone and 2,4-diethylthioxanthone, xanthone and its derivatives, and anthraquinone and its derivatives.

Type II photoinitiators are used with particular advantage in combination with nitrogen-containing coinitiators, known as amine synergists. Preference in the context of this invention is given to using tertiary amines. Furthermore, in combination with type II photoinitiators, hydrogen atom donors are advantageously employed. Examples thereof are substrates which contain amino groups. Examples of amine synergists are methyldiethanolamine, triethanolamine, ethyl 4-(dimethylamino)benzoate, 2-n-butoxyethyl 4-(dimethylamino)benzoate, isoacryloyl 4-(dimethylamino)benzoate, 2-(dimethylaminophenyl)ethanone, and also unsaturated and therefore copolymerizable tertiary amines, (meth)acrylated amines, unsaturated amine-modified oligomers, and polyester-based or polyether-based polymers, and amine-modified (meth)acrylates.

It is possible, moreover, to use polymerizable photoinitiators of type I and/or type II which either themselves are present as oligomeric or polymeric photoinitiators or are copolymerized as a polymerizable photoinitiator with other polymerizable substances, monomers for example, and are then present as a copolymer having photoinitiator functions.

In the sense of this invention it is also possible to use any desired combinations of different kinds of type I and/or type II photoinitiators.

Moreover, optionally but advantageously, the coating comprises further constituents such as catalysts, accelerators, light stabilizers such as, in particular, UV stabilizers, aging inhibitors, antioxidants, further stabilizers, flame retardants, flow control agents, wetting agents, lubricants, defoamers, deaerating agents, adhesion promoters, further additives with rheological activity such as, for example, thixotropic agents, matting agents and/or further fillers.

A coating suitable in accordance with the invention for the surface protection film is selected on the basis of the Martens hardness of the coating film. The Martens hardness is preferred here over the Shore hardness because the former is suitable for thin layered structures, as are constituted by surface protection films, because the measuring forces and hence the depths of penetration are low. The elastic recovery can likewise be calculated from the measurement data. The Shore hardness test cannot be employed for thin layers.

In accordance with the invention, the Martens hardness of the coating layer is in a range from 2 N/mm² to 3.5 N/mm², preferably in a range from 2 N/mm² to 3 N/mm², preferably in a range from 2 N/mm² to 2.5 N/mm². At a Martens hardness below 2 N/mm², the surface protection film still has self-healing properties, but as the Martens hardness decreases further, the coating becomes too soft and the abrasion determined in the pour test becomes greater.

Preference is given to a coating formulation which comprises at least one kind of inorganic oxide in nanoparticulate form, the average particle diameter of the inorganic oxides typically being below 100 nm. A particle diameter of less than 30 nm is preferred. Nanoparticles are able to increase the abrasion resistance of a coating layer, while retaining the transparency, without the Martens hardness increasing too highly.

“Particles” are understood in the sense of DIN 53206-1: 1972-08 to refer to primary particles, aggregates, and agglomerates of the inorganic oxide. The “particle size” means the maximum extent of a particle. The particle size is determined preferably by laser diffraction according to ISO 13320, although other methods known to the skilled person are suitable as well.

The surface of these particles is preferably functionalized such that the particles not only form a stable suspension in the organic matrix formed by the coating resin mixture, but can also be chemically linked to the organic network as it forms in the course of curing. It is particularly advantageous if such surface functionalization is accomplished by reaction of the particles with coupling reagents such as, in particular, unsaturated silanes or titanates (in this regard see, for example, L. N. Lewis, D. Katsamberis, J. Appl. Polym. Sci., 1991, 42, 1551, EP 1 366 112 B1 to Hansechemie, EP 2 292 703 A1 to Cetelon Lackfabrik or U.S. Pat. No. 6,136,912 A to Clariant S A).

Included in such formulations with particular advantage are amorphous silicas or corundum. The fraction may be up to 50 wt %. Advantageous particle contents are up to 20 wt %, preferably up to 10 wt %. Advantageously, there is more than 1 wt % included. With particular preference the context is between 1 wt % and 10 wt %.

The thickness of the coating is in a layer thickness customary for the skilled person, in other words approximately from 0.5 up to 30 μm. A thickness of 12 μm or less is preferred, since in that case the Martens hardness according to the invention is more easily achievable with acrylate-based coatings. Especially preferred are a thickness of 12 μm or less and a Martens hardness of less than 3 N/mm².

The polymer film may be selected from the elastomeric polymer films known to the skilled person. By way of example, though without restriction, mention may be made of polymeric films composed of:

Polyolefins such as polyethylene (PE) and its copolymers such as, for example, ethylene-vinyl acetate (EVA), ethylene-acrylate (EAA), ethylene-methacrylate (EMA), and also ionomers, PVC, fluoropolymers, styrene block copolymers (SBC), and polyurethane, and also of mixtures (blends) of elastomers with one another or with other polymers.

An elastomer consists in principle of polymer chains (depending on chemical construction) with only wide-mesh crosslinking. When low external forces are applied within the service temperature range, the polymer chains slide with respect to one another, and the crosslinking bonds, though stretched, nevertheless remain joined to one another and possess a recovery force. Crosslinking may be present chemically or physically, the latter also including crosslinking by means of interlooping of the molecular chains, resulting from the fact that the weight average M_{w} of the elastomer corresponds at least to 5 times, preferably to 25 times, the entanglement molecular weight.

Preferred in particular is a polyurethane film which comprises an aliphatic polyurethane, since these films are particularly weathering-stable and elastic. Especially preferably the polymer film comprises a polycaprolactone-based thermoplastic polyurethane, since such a film is particularly weathering-stable.

The thickness of the polymer film is in the range of protective film thicknesses known to the skilled person, in other words, for instance, in the range from 10 μm to 1000 μm.

The polymer film suitable in accordance with the invention for the surface protection film is selected according to the Martens hardness and to the elastic film recovery determined in the same test.

In accordance with the invention the Martens hardness of the polymer film is in a range from 2 N/mm² to 4 N/mm², preferably in a range from 2 N/mm² to 3 N/mm², preferably in a range from 2 N/mm² to 2.5 N/mm². At a Martens hardness below 2 N/mm², the film is too soft and the coating layer can be pressed too easily into the film, and damaged, in the event of mechanical exposure. At a Martens hardness of more than 4 N/mm², the film is too hard and hence dimensionally stable, and so the coating layer breaks more easily in the bend test, and the impact wear determined in the pour test becomes greater.

The Martens hardness is determined according to the method specified below. The same method was also used to determine the elastic recovery of the polymer film.

The elastic recovery in accordance with the invention is more than 70%, preferably more than 76%, very preferably more than 80%. The elastic recovery of the film supports the self-healing properties of the first layer, and so, surprisingly, the combination of a first layer according to the invention and a film with elastic recovery and hardness according to the invention results in an advantageous self-healing surface protection film. Surprisingly, in the combination, it is not the hardest elastomeric film, which generally also has the greatest elastic recovery, that exhibits the best surface protection properties, but rather a comparatively soft film which, however, exhibits a high elastic recovery capacity. For a film whose hardness is in accordance with the invention, a high elasticity is advantageous for the self-healing properties; the upper limit, accordingly, is 100%.

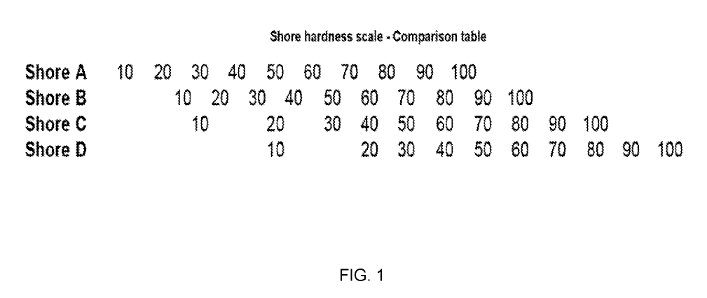

Thermoplastic polyurethane films in particular are available in a broad hardness range, the hardness generally being specified as Shore hardness. The commercial offering, for the films from BASF (Elastollan) and from Covestro (Dureflex, Platilon U), for example, embraces a spectrum which ranges from 71 Shore A up to 73 Shore D. All of the thermoplastic polyurethane films available have an elongation at break of more than 250%. A comparative scale illustrating the transition from Shore A to Shore D is shown in FIG. 1.

In one preferred version, the polymer film has a hardness in a range from 85 Shore A, more particularly from 90 Shore A, up to 45 Shore D, determined on the basis of DIN ISO 7619-1 by the method specified below.

The Shore hardness range corresponds in its extent, essentially, to the Martens hardness range according to the invention. It is cited only to allow an approximate comparison with solutions from the prior art. The Shore hardness test is more commonplace for elastomers, but cannot be applied to the present thin films. The measurement, moreover, gives no result for the elastic recovery capacity.

The adhesive layer is preferably a hotmelt adhesive layer or a pressure-sensitive adhesive layer. With particular preference it comprises at least one pressure-sensitive adhesive and therefore has pressure-sensitive adhesive properties at a temperature above 20° C.

“Pressure-sensitive adhesive” (PSA) is the term for adhesives which permit a durable join to the substrate even under relatively weak applied pressure and which after use can be detached from the substrate again substantially without residue. PSAs have a permanently pressure-sensitive adhesive effect at room temperature, hence having a sufficiently low viscosity and a high initial tack, allowing them to wet the surface of the respective substrate even under low applied pressure. The bondability of the adhesives derives from their adhesive properties, and the redetachability from their cohesive properties. A variety of compounds are suitable as a basis for PSAs.

PSAs which can be used are all PSAs known to the skilled person; in other words, for example, those based on acrylates and/or methacrylates, polyurethanes, natural rubbers, synthetic rubbers, styrene block copolymer compositions with an elastomer block composed of unsaturated or hydrogenated polydiene blocks (polybutadiene, polyisoprene, copolymers of both, and also other elastomer blocks familiar to the skilled person), polyolefins, fluoropolymers and/or silicones. They also include further compositions which possess pressure-sensitively adhesive properties in accordance with the “Handbook of Pressure Sensitive Adhesive Technology” by Donatas Satas (Satas & Associates, Warwick 1999).

Where this specification refers to acrylate-based PSAs, the reference, even without explicit mention, is to PSAs based on methacrylates and based on acrylates and methacrylates, unless expressly described otherwise. Likewise within the meaning of the invention are combinations and blends of two or more base polymers, and also adhesives additized with tackifier resins, fillers, aging inhibitors, and crosslinkers, where the enumeration of the additives should be understood to be only by way of example and without restriction.

The thickness of the adhesive layer is in the range of adhesive layer thicknesses known to the skilled person, in other words, for instance, in the range from 1 μm to 500 μm.

Composite films of the invention are produced in methods known to the skilled person, as described comprehensively for example in DE 20 2006 021 212 U1 or DE 10 2006 002 596 A1.

Hence the acrylate coating layer may be formed conventionally, as for example by application of the mixture of aqueous dispersion or solution in a solvent, but preferably without the use of solvent or dispersion medium.

For the purposes of this invention, any of the methods known to the skilled person may in principle be selected for the coating of the coating mixtures of the invention onto polymer films. Without wishing to be subject to any restriction, mention may be made, by way of example, of doctor blade methods, roll methods such as, in particular, engraved-roll methods, dipping methods, spraying methods, knife methods, brush methods, pouring methods, and printing methods such as, in particular, offset or flexographic printing methods. Combinations of different methods are also conceivable, such as, for example, the Mayer Bar method, a coating operation which combines rolls and doctor blades with one another, or roll/pour systems, in which rolls and doctor blades are combined with one another and the principle of pour coating is incorporated as well. Certain methods which can be used in accordance with the invention can be found, for example, in Scharenberg [R. T. Scharenberg in Encyclopedia of Polymer Science and Engineering, H. F. Mark, N. M. Bikales, C. G. Overberger, G. Menges (eds.), 3rd volume, 2nd edn., 1985, Wiley, New York].

In order to eliminate atmospheric oxygen, which has an inhibiting effect on curing of the coating, all prior-art methods and also combinations of different such methods can be employed in the context of this invention.

Diverse possibilities have been proposed in the literature as to how to eliminate the adverse effect of atmospheric oxygen on the curing operation. A series of original papers describing such routes are collated by Studer et al. [K. Studer, C. Decker, E. Beck, R. Schwalm, Progr. Org. Coat., 2003, 48, 92]. In this compilation, accordingly, the use of amines, the use of substances capable of converting triplet oxygen into singlet oxygen, an increased amount of photoinitiator employed, a higher UV dose, the introduction of protective layers based on wax or on water films, a higher monomer reactivity, and a higher viscosity of the coating formulation are identified as beneficial to eliminating the inhibitory effect of atmospheric oxygen. Specific types of photoinitiator have been tested for the same purpose [N. J. Hageman, L. G. J. Jansen, Makromol. Chem., 1988, 189, 2781].

One elegant route is the displacement of atmospheric oxygen by using an inert atmosphere such as nitrogen, argon or carbon dioxide. Examples of such processes were published some time ago in U.S. Pat. No. 3,840,448 by Union Carbide Corp. and by Studer et al. [K. Studer, C. Decker, E. Beck, R. Schwalm, Progr. Org. Coat., 2003, 48, 92 and also ibid, 101].

With particular preference, after the coating formulation has been coated onto the polymer film, a protective film is laid on wet and then irradiation and hence curing take place through this protective film [A. van Neerbos, J. Oil Col. Chem. Assoc., 1978, 61, 241]. The coated and irradiated polymer film then forms a first composite film and can then be further processed together with the protective film, in other words, for example, coated with the adhesive layer, rolled up into bales or supplied directly to slitting or diecutting operations. The protective film is removed at any desired point in time after the at least one curing step, as for example only after the composite film of the invention has been applied, in the context of its use. In a further variant, the protective film as well may initially be coated with the coating material, and then the polymer film can be laminated on.

The protective film is preferably transparent, especially if electromagnetic radiation such as UV radiation is employed for curing. Film materials which can be used for protective films employable in accordance with the invention are in principle all of those which can be delaminated again after the liquid coating layer has been crosslinked, without damage to the coating layer which at this point is substantially cured. It is therefore important that the film surface does not react chemically with the coating layer as it cures. For this purpose, the protective film may also be provided with a special layer, such as a release layer, as for example a siliconization, or a release layer based on polyolefins, more particularly polyethylene, or based on partially fluorinated or perfluorinated hydrocarbons, especially those polymeric in type. In the inventive sense it is possible, for example, to use polyolefin films or polyester films, as have been described in the literature [EP 0 050 996 B1 to Mitsui Petrochemical; C. Peinado, E. F. Salvador, A. Alonso, T. Corrales, J. Baselga, F. Catalina, J. Polym. Sci. A—Polym. Chem, 2002, 40, 4236], or others which satisfy this requirement.

Particularly preferred as protective films employed are those types of film which, in addition to the criteria stated above, additionally have a defined roughness on the side facing the coating layer. For high-quality optical applications in particular, a gloss perceptible to the human eye is not sufficient, under certain circumstances [P. Dufour in Chemistry & Technology of UV & EB Formulation for Coatings, Inks & Paints, P.K.T Oldring (eds.), volume 1, 1991, SITA Technology, London, p. 27] as a criterion of the surface quality of protective films which can be used. The usability of protective films is instead evaluated via the surface roughness. Protective films which can be used with particular preference have a roughness, on the side facing the coating layer, provided by R_{z} values of at most 0.3 μm, preferably of at most 0.15 μm, very preferably of at most 0.08 μm.

The surface roughness of the protective film is determined using a Perthometer PGK from Mahr, equipped with an MFW250 feeler tip. The specimens are cut into test specimens measuring approximately 10 cm×10 cm, and are fixed on the measuring table by magnets. The conical feeler tip is moved carefully toward the specimen up to a point such that it comes just into contact with the specimen surface. The lateral measuring range is ±25 μm. The feeler tip is then run over the test specimen in a straight line over a distance of 1.75 mm at a speed of 0.1 mm/s, and in the course of this operation vertical deflections are recorded and used to construct a height profile. From the raw data, the surface roughness is evaluated in accordance with DIN EN ISO 4287 as the greatest height of the profile R_{z}. Three measurements are carried out in each case, in the direction of coating, and the average of the individual measurements is reported in μm.

After the application of the coating formulation, and after the optional but particularly preferred construction of a composite of the polymer film, the applied coating, and a protective film, the liquid, preferably solvent-free and dispersion medium-free coating layer undergoes a curing process. This may be accomplished by all of the methods known to the skilled person for stimulating the polymerization of acrylate compounds—in other words, for example, by heat. For the purposes of this invention, radiation-chemical methods are preferably employed for this purpose. Such methods encompass exposure to electromagnetic radiation such as, in particular, to UV radiation and/or to particulate radiation such as, in particular, electron beams. By means of short-term exposure to light in a wavelength range between 180 to 500 nm and/or to accelerated electrons, the applied coating material is irradiated and thereby cured. In the case of UV irradiation, high-pressure or medium-pressure mercury lamps in particular are employed, at a power of 80 to 240 W/cm. Other radiation sources which can be used for the purposes of this invention are familiar to the skilled person. Either the emission spectrum of the lamp is tailored to the photoinitiator employed, or the nature of the photoinitiator is adapted to the lamp spectrum.

The intensity of irradiation is adapted to the respective quantum yield of the UV photoinitiator and to the web speed.

Where irradiation with accelerated electrons is employed for the curing of the coating layer, as may also take place in combination with UV crosslinking, typical irradiation equipment then includes linear cathode systems, scanner systems, or segmented cathode systems where electron beam accelerators are involved. Typical acceleration voltages are in the range between 50 kV and 1 MV, preferably 80 kV and 300 kV. The irradiation doses employed are between 5 to 250 kGy, more particularly between 20 and 100 kGy.

Coated application of the mixture of the invention in liquid phase to a detachable carrier according to known processes is within the abilities of the skilled person. Suitable detachable carriers include, among others, films such as biaxially oriented polyester films, and papers, which optionally have been printed or coated with a composition which will enable separation from the acrylate compositions. Such coatings include, among others, those composed of silicon or fluorochemical compounds. The application of the mixture of aqueous dispersion or solution in a solvent to a carrier may be accomplished here via equipment known per se to the skilled person, such as doctor blades, roll coaters, reverse roll coaters, notched bar coaters, curtain coaters, rotary gravure coaters, rotary printers, and the like. For this purpose, the viscosity of the aqueous or solvent-containing mixture may be adapted to the particular coater. After the mixture has been applied, the water and/or the solvent is removed therefrom by drying, for example.

The polymer film layer may be formed by shaping of the polymer at an elevated temperature by way of an extrusion die. The polymer film layer may also be formed by bringing the polymer into the desired form by casting or another shaping process (such as injection molding, for example).

The adhesive layer may be applied in all of the methods known to the skilled person, as for example by coating, casting, printing or laminating. Examples of specific methods have already been identified for the application of the coating.

The adhesive layer may be applied to the polymer film before or after the first layer.

In order to enable or at least to improve the bonding between polymer film and adhesive layer or coating and polymer film, it may be desirable to subject the major surface of the shaped polymer film layer to be joined to the adhesive layer, and/or the adhesive layer, to a plasma treatment (such as, for example, an air or N₂ corona treatment) and to thermal lamination. For this purpose, the major surface of the polymer film layer that is not adjacent to the coating layer is exposed and subsequently treated with a plasma.

The composite films of the invention are used preferably as surface protection films and decorative films.

The present inventive composite film is customarily transparent and possibly even translucent for coating protection applications. For the protection or enhancement of other surfaces as well, the present inventive composite film may be made transparent, translucent or even opaque. For certain applications it may also be desirable to color the present composite film. For that purpose, the present film may for example be provided additionally with a pigment or another colorant in one or more of its layers, or a further layer with a colorant may be integrated into the composite—a printing layer, for example.

Where the present composite film is to serve, for example, as a coating protection film, it has proven desirable for it to be formatted accordingly in terms of size and design before it is applied to the area to be protected. Sections of the present composite film preformatted accordingly, indeed, may well prove commercially desirable in respect of protection of the coated surface of various bodywork parts of a vehicle, such as, for example, of a motor vehicle, aircraft, watercraft, etc., particularly with regard to the parts of the vehicle bodywork (such as, for example, the leading edge of the front end and other leading surfaces, door sill panels, etc.), against stone chipping and soiling as a result of dust and of insect strike and the like.

### EXAMPLES

Measurement Methods Used:

Pour Test with Gloss Measurement

The test determines the abrasion resistance under impact exposure, as is relevant, for example, for the anti-stonechip effect of a surface protection film. The investigation is carried out at 23° C. and 50% relative humidity.

Prior to the pour test, a gloss measurement is performed at an angle of 20° in accordance with EN ISO 2813 using the REFO 3D reflectometer from HACH LANGE on the specimens bonded to black metal panels measuring 10×10 cm². Then, in a procedure based on DIN 52348, approximately 2 kg of angular steel castings with a granulation of 0.2 to 0.7 mm and a hardness of 64 to 68 HRC (in accordance with EN ISO 11124; Steelstra G H 50 from Stratec) are poured from an average drop height of 910 mm on to the specimen panel inclined at an angle of 45°. After the pour test, the gloss is again measured with the REFO 3D, and the loss of gloss in gloss units is computed.

Sclerometer Test

In this test, in a procedure based on DIN EN ISO 1518-1, the coating surface is scratched in a defined manner. Using a hardness test pencil (model 318S from Erichsen), scratching takes place with engraving tips No. 1 (0.75 mm) and No. 2 (1 mm tip radius) under an applied force of 5 N over the coating surface of the specimens bonded to black metal panels. The depth of the scoring and its recovery are assessed qualitatively. The recovery is also a measure of the self-healing capacity of the surface protection film. Martens hardness (surface hardness according to DIN EN ISO 14577-1) The surface hardness is measured on a FischerScope HCU from HELMUT FISCHER GmbH & Co. KG at a temperature of 23° C. and a relative humidity of 50%. The Martens hardness (HM) is determined in N/mm² at maximum test force. The Martens hardness (universal hardness up to 2003) is defined as the ratio of the maximum force to the associated contact area. The testing body used is a Vickers diamond pyramid. The shape correction for the indentor is not taken into account in the standard setting.

The measurement is made continuously under force control with an increase from 300 mN/20 s up to a maximum testing force of 300 mN. After a hold time of 5 s, release takes place at the same rate (parameters referenced according to ISO 14577-1: HM 0.300/20.0/5.0).

During the measurement, the force and the depth of penetration are recorded continuously.

The depth of penetration is plotted against the force.

For the determination of elastic recovery, the difference between the depth of penetration after the hold time at maximum force and the remaining depth of penetration immediately after recovery of the force to zero is divided by the depth of penetration after the hold time at maximum force, and expressed as a percentage.

The surface hardness and elastic recovery of the coatings are determined on the respective polymer film substrate.

Shore A Hardness Testing

The Shore A hardness measurement is carried out in a procedure based on DIN ISO 7619-1 using a durometer. Measurement is made only on films having a minimum thickness of 200 μm, which for the measurement are bonded without bubbles to a rigid substrate using a double-sided adhesive tape with a thickness of no more than 60 μm. Testing takes place at 23° C. and 50% relative humidity, with a test duration of 3 s. The average value from five measurements is reported.

Bend Test

The bend test is a flexural test over a defined radius, and in the case of hard coatings may result in the rupturing or flaking of the coating. In the test, a specimen lined on the adhesive side (adhesive thickness 60 μm) with a silicone liner 50 μm thick is bent/folded with the fingers (180°), and then the liner is removed and the specimen is bonded to a black metal panel for visual inspection. The bending radius therefore corresponds to the thickness of the polymer film layer plus the adhesive thickness and liner thickness. The bent fold which results can be monitored very effectively in this way for cracks, fractures or flaking.

Yellowing

For this purpose, specimens of the surface protection film are adhered to a white substrate (ceramic tile) and irradiated at room temperature from a distance of approximately 50 cm using a sunlight lamp (Osram 300 W ULTRA-VITALUX, 30° emission angle, 13.6 W UV-A, 3 W UV-B). Measurements are made of the degree of yellowing b* and the change therein relative to the initial value, Δb* (taken from the L*a*b* color space in accordance with DIN 5033) by the spectral method using standard illuminant D65 from the observer angle of 10° with the spectro-guide from BYK-Gardner (sphere d/8 spin) after the specified storage time (generally two weeks).

Layer Thickness

The layer thickness is determined via scanning electron microscopy (SEM). The samples are cut under liquid nitrogen. Overview micrographs and detailed micrographs are made of the cross sections. The thickness of the layer of protective coating is measured on the polymer film layer.

Molecular Weight

The molecular weight determinations of the number-average molecular weights Mₙ and of the weight-average molecular weights M_{w} were made by means of gel permeation chromatography (GPC). The eluent used was THF (tetrahydrofuran) with 0.1 vol % of trifluoroacetic acid. Measurement took place at 25° C. The precolumn used was PSS-SDV, 5μ, 10³ Å, ID 8.0 mm×50 mm. Separation took place using the columns PSS-SDV, 5μ, 10³ and also 10⁵ and 10⁶ each with ID 8.0 mm×300 mm. The sample concentration was 4 g/l, the flow rate 1.0 ml per minute. Measurement took place against polystyrene standards.

Materials Used:

Polymer Films Used were as Follows:

TABLE 1
Polymer films

| | | | | Martens | Elastic | |
|---|---|---|---|---|---|---|
| | | | Thickness | hardness | recovery | Shore |
| Designation | Manufacturer | Type | [μm] | [N/mm²] | [%] | hardness |
| K82250 | KPMF | Thermopl. aliph. | 250 | 2.07 | 75 | 90 A |
| | | PU | | | | |
| K82200 | KPMF | Thermopl. aliph. | 200 | 2.21 | 77 | 90 A |
| | | PU | | | | |
| Platilon | Epurex | Thermopl. | 250 | 4.43 | 89 | 93 A |
| U 2102 AK | | polyester-PU | | | | |
| 250 | | | | | | |

The first layer (acrylate coating layer) for the surface protection film was produced using the following ingredients:

TABLE 2.1
Ingredients used for the acrylate coating layer

| | Product | | |
|---|---|---|---|
| Manufacturer | designation | Chemical structure | Remarks |
| Allnex | Ebecryl 284 | Aliphatic urethane acrylate | difunctional |
| | | oligomer based on polyester, | |
| | | difunctional, M_{w} ~1200 g/mol | |
| | | diluted with 12 wt % HDDA | |
| Allnex | Ebecryl 4738 | Aliphatic urethane acrylate oligomer | trifunctional |
| | | with allophanate structure | |
| | | trifunctional, M_{w} ~850 g/mol | |
| Allnex | HDDA | 1,6-Hexanediol diacrylate | difunctional |
| Allnex | TPGDA | Tripropylene glycol diacrylate | difunctional |
| Allnex | DPHA | Dipentaerythritol hexaacrylate | hexafunctional |
| Miwon | Miramer M210 | Hydroxyl pivalic acid neopentyl | difunctional |
| | | glycol diacrylate | |
| Rahn | ACMO | Acryloyl morpholine | monofunctional |
| Rahn | IBOA | Isobornyl acrylate | monofunctional |
| | (Genomer 1121) | | |
| Allnex | Ebecryl 7100 | Amine-functional acrylate | amine synergist |
| | | | for curing |
| BASF | Irgacure 500 | Mixture of two photoinitiators: | photoinitiator |
| | | 50 wt % 1-hydroxycyclohexyl | system |
| | | phenyl ketone | |
| | | and 50 wt % benzophenone | |
| Evonik- | Nanocryl A210 | Colloidal silica (<20 nm) in | nanoparticle |
| Hanse | | 1,6-hexanediol | dispersion |
| | | diacrylate, 50 wt % | |

Production of Topcoats:

From the ingredients, the following coating materials were produced:

TABLE 2.2
Coating materials produced

| Raw material/Coating No. | L1 | L2 | L3 | L4 | L5 |
|---|---|---|---|---|---|
| Ebecryl 284 | | 50 | 50 | 50 | |
| Ebecryl 4738 | 37 | | | | |
| Miramer M210 | 8 | | | | |
| HDDA | 50 | | 50 | | 31 |
| TPGDA | | | | | 31 |
| DPHA | | | | | 8 |
| ACMO | | 50 | | | 30 |
| IBOA | | | | 50 | |
| Ebecryl 7100 | 3 | 3 | 3 | 3 | 3 |
| Irgacure 500 | 4 | 4 | 4 | 4 | 4 |
| Nanocryl A210 | 5 | | | | |

The figures are the parts by weight in the formulation.

For the production of the coating, the components are combined in the desired proportion at room temperature and mixed thoroughly by means of a laboratory stirrer.

Production of the Applied Coats:

When the components are thoroughly mixed, the topcoat is applied using a doctor blade to polymer film K82250 from KPMF (Kay Premium Marking Films Ltd., Newport). The coats were applied using a wire doctor blade (Mayer Bar). After the coating process, the coating layer was lined bubble-free with a 50 mm thick polyester film from DuPont (Melinex 401).

After having been lined, the specimen was UV-crosslinked at a belt speed of 10 m/min on a continuous UV laboratory irradiation unit from Eltosch, using a mid-pressure mercury lamp with a lamp output of 160 Watts/cm (dose about 80 mJ/cm²).

The K82250 stonechip protection film comprises a polymer film made of polycaprolactone-based polyurethane (thickness 250 μm) and also a layer of an acrylate PSA (thickness 60 μm).

As a comparative example with a polyurethane-based rather than an acrylate-based coating, the product K82255 was used, likewise a polycaprolactone-based polymer film (thickness 250 μm) with a layer of an acrylate PSA (thickness 60 μm).

TABLE 3
Measurement results
Overview of the trials and tests:

| | | | Thickness | | | | | | |
|---|---|---|---|---|---|---|---|---|---|
| | | | of coating | | | | | Yellowing | |
| | | | layer | | | Gloss 20° | Gloss 20° | 2 weeks | Martens |
| | Polymer | Coating | (SEM) | Sclerometer test | | before | after | sunlamp | hardness |
| | film | No. | [μm] | (1 mm) | Bend test | pouring | pouring | b* | [N/mm²] |
| No. | | | | | | | | | |
| example | | | | | | | | | |
| 1 | K82250 | 1 | 15 | no scratches, trace | bend crease, a | 83.3 | 75.4 | 1.09 | 2.25 |
| | | | | impressions fresh, no | few small | | | | |
| | | | | longer visible after | fractures | | | | |
| | | | | two days | parallel to the | | | | |
| | | | | | bend | | | | |
| 2 | K82250 | 1 | 12 | no scratches, trace | bend crease, | 80.5 | 77.6 | 0.97 | 2.22 |
| | | | | impressions fresh, no | no fracture | | | | |
| | | | | longer visible after | | | | | |
| | | | | two days | | | | | |
| 3 | K82250 | 1 | 8 | no scratches, trace | bend crease, | 81.9 | 78.9 | 1.09 | 2.40 |
| | | | | impressions fresh, no | no fracture | | | | |
| | | | | longer visible after | | | | | |
| | | | | two days | | | | | |
| 4 | K82250 | 1 | 3 | no scratches, trace | bend crease, | 84.2 | 69.5 | 1.00 | 2.26 |
| | | | | impressions fresh, no | no fracture | | | | |
| | | | | longer visible after | | | | | |
| | | | | two days | | | | | |
| 5 | K82250 | 1 | 1 | no scratches, trace | bend crease, | 84.1 | 77.5 | 1.06 | 2.04 |
| | | | | impressions fresh, no | no fracture | | | | |
| | | | | longer visible after | | | | | |
| | | | | two days | | | | | |
| 6 | K82250 | 2 | 12 | no scratches, trace | bend crease, | 84.0 | 73.6 | 1.89 | 3.11 |
| | | | | impressions fresh, no | no fracture | | | | |
| | | | | longer visible after | | | | | |
| | | | | two days | | | | | |
| 7 | K82250 | 2 | 9 | no scratches, trace | bend crease, | 80.8 | 69.2 | 1.09 | 2.42 |
| | | | | impressions fresh, no | no fracture | | | | |
| | | | | longer visible after | | | | | |
| | | | | two days | | | | | |
| 8 | K82250 | 3 | 17 | no scratches, trace | bend crease, | 81.2 | 74.8 | 1.62 | 2.03 |
| | | | | impressions fresh, no | small cracks in | | | | |
| | | | | longer visible after | the bend and a | | | | |
| | | | | two days | few parallel to it | | | | |
| 9 | K82250 | 4 | 8 | no scratches, trace | bend crease, | 81.1 | 52.2 | 1.38 | 2.01 |
| | | | | impressions fresh, no | no fracture | | | | |
| | | | | longer visible after | | | | | |
| | | | | two days | | | | | |
| 10 | K82250 | 5 | 0.5 | no scratches, trace | bend crease, | 82.6 | 71.6 | 1.33 | 2.33 |
| | | | | impressions fresh, no | no fracture | | | | |
| | | | | longer visible after | | | | | |
| | | | | two days | | | | | |
| Comparative | | | | | | | | | |
| example | | | | | | | | | |
| C1 | K82255 | PU | 20 | trace impressions | bend crease, | 84.9 | 51.5 | 1.5 | 3.51 |
| | | | | fresh, still slightly | no fracture | | | | |
| | | | | visible after 2 days | | | | | |
| C2 | Platilon U | 1 | 13 | significant trace | bend crease, | 81.1 | 77.5 | 1.21 | 5.39 |
| | 2102 | | | impressions, still | cracks parallel | | | | |
| | | | | clearly visible after 2 | to the bend | | | | |
| | | | | days | | | | | |
| C3 | K82250 | 5 | 9 | significant trace | bend crease, | 82.8 | 73.6 | 1.27 | 4.24 |
| | | | | impressions, still | cracks parallel | | | | |
| | | | | clearly visible after 2 | to the bend | | | | |
| | | | | days | | | | | |

In accordance with the invention, the suitable Martens hardness of the coating layer for a self-healing surface protection film is in a range from 2 N/mm² to 3.5 N/mm², as the examples show. Preferred is a range from 2 N/mm² to 2.5 N/mm², in which the examples show balanced properties. At a Martens hardness below 2 N/mm², the coating is too soft and the abrasion determined in the pour test becomes higher, as may be determined from example 9. If the Martens hardness is above 3.5 N/mm², self-healing is no longer achieved in spite of the use of an inventive polymer film (comparative example C3).

Thicker coatings generally exhibit greater brittleness (example 1 vs. example 2 and also example 6 vs. example 7), and so the Martens hardness is increased overall (example 6) and/or the bend test is not passed (example 1). A layer thickness of 12 μm or less is therefore preferred.

For more brittle coatings, preferably those which contain no long-chain acrylate oligomer with a functionality of two or more, such as urethane acrylate, for example, a thickness of less than 2 μm is advantageous, since in that case it is possible to construct a usable surface protection film in the composite of the invention with the elastically recovering polymer film (example 10 vs. comparative example C3). This particular result is surprising, since the skilled person would have expected it not to be possible to produce self-healing surface protection films on the basis of coatings (L5) containing exclusively monomers with a functionality of one or more.

One particularly preferred embodiment, therefore, is the combination of a coating material whose coating basis comprises exclusively monomers as reactive components, at least one of the monomers having at least two (meth)acrylate functions, with an inventive polymer film, the thickness of the coating layer being 2 μm or less. As a lower limit on the thickness of the coating layer, it is preferred not to go below 0.1 μm, since below that limit there is a decrease in the abrasion resistance in the pour test. With preference there are additionally monomers present which are only monofunctional.

The coating basis is taken to be all of the formulation ingredients which build up the organic basis of the coating material—that is, reactive constituents such as monomers, oligomers, and polymers, and also nonreactive organic (optionally oligomeric or polymeric) constituents such as plasticizers, waxes, and oils. Initiators, sensitizers, fillers, pigments, light stabilizers, aging inhibitors, and other customary adjuvants do not form part of the coating basis.

“On the basis of” or “based on” means in the present context that the properties of the coating are at least strongly determined by the fundamental properties of the coating basis;

of course, this does not rule out an additional influence on these properties through the use of modifying auxiliaries or adjuvants in the composition. This may mean in particular that the fraction of the coating basis as a proportion of the total mass of the coating material is more than 50 wt %.

Comparative example C1 is a commercial surface protection film composed of a thermoplastic polyurethane polymer film with a polyurethane coating layer. This represents the market standard in terms of the customary requirements of surface protection films, such as scratch resistance (sclerometer test), gloss, abrasion resistance (pour test), bend resistance, and yellowing. A comparison with the inventive examples shows that the properties of the market standard are consistently achieved. In the area of abrasion resistance, they are in fact regularly exceeded. C1 is not self-healing; here, the inventive surface protection films have advantages.

Comparative example C2 uses a polymer film having a Martens hardness of more than 4 N/mm². As a result, the surface protection film no longer has self-healing properties. The Platilon U 2102 polymer film used, moreover, has an elongation at break of 450%, whereas the inventive polymer film K82250 achieves only an elongation at break of around 250%. Here it can be shown that the Martens hardness and the elastic recovery do not correlate with the elongation at break in such a way that a more extensive film can be assessed as being softer or more elastic than a less extensive film. Consequently, the teaching of WO 92/22619 A1, which is to use films and coating materials of maximum extensiveness (see, in particular, claims 1, 10-12, 16, 18, 19, and 30), must be rejected.

Comparative example C3 uses an inventive polymer film. The coating, however, has a Martens hardness of more than 3.5 N/mm². As a result, the surface protection film no longer has self-healing properties.

Surprisingly it was found that identical coating materials applied to harder polymer films no longer exhibited self-healing properties and were less bend-resistant (comparative example C2 vs. example 2).

C2 and C3 also show weaknesses in the bend test, since both an excessively hard film and an excessively hard coating result in cracking. These surface protection films therefore do not achieve the commercial standard (C1).

1. A composite film comprising the following layers:
a coating layer
a polymer film layer comprising a major surface and an opposite major surface, and
an adhesive layer,
wherein the coating layer is joined to the one major surface of the polymer film layer, and the adhesive layer is joined to the opposite major surface of the polymer film layer, such that the polymer film layer is embedded between the coating layer and the adhesive layer, and
wherein
the coating layer is an acrylate coating layer produced from a coating formulation which comprises a compound with at least two (meth)acrylate functions;
the coating layer at room temperature has a surface hardness (HM 0.300/20.0/5.0) of 2.0 to 3.5 N/mm²; and
the polymer film layer at room temperature has a surface hardness (HM 0.300/20.0/5.0) of 2.0 to 4.0 N/mm², and an elastic recovery after the surface hardness measurement with a release rate of 300 nN/20 s of more than 75%.

2. The composite film as claimed in claim 1, wherein the formulation comprises a compound having exactly two (meth)acrylate functions, and does not comprise a compound having than two (meth)acrylate functions.

3. The composite film as claimed in claim 1, wherein the coating formulation comprises a urethane (meth)acrylate.

4. The composite film as claimed in claim 1, wherein the compound having at least two (meth)acrylate functions is present at a weight fraction of more than 30 wt % of the total amount of compounds carrying (meth)acrylate or vinyl functions in the coating formulation.

5. The composite film as claimed in claim 1, wherein the coating formulation comprises a compound having at least two (meth)acrylate functions, and further comprising a compound having one (meth)acrylate function.

6. The composite film as claimed in claim 1, wherein the coating formulation comprises exclusively monomers, wherein at least one of the monomers polyfunctional.

7. The composite film as claimed in claim 1, wherein the compound having a (meth)acrylate function or (meth)acrylate functions is prepared using (meth)acrylate monomers of the formula (I):
CH₂═C(R1)(COOR2) (I)
where R1 is independently H or CH₃ and R2 is independently H or linear, branched or cyclic, saturated or unsaturated alkyl radicals having 1 to 30 carbon atoms.

8. The composite film as claimed in claim 1, wherein the coating formulation for producing the acrylate coating layer further comprises a compound which comprises a morpholine group and a vinyl group.

9. The composite film as claimed in claim 1, wherein the coating formulation comprises nanoparticles.

10. The composite film as claimed in claim 1, wherein the acrylate coating layer has a thickness of 0.5 to 30 μm.

11. The composite film as claimed in claim 1, wherein the polymer film layer is a film of a compound selected from the group consisting of polyvinyl chloride, polyethylene, copolymers of polyethylene, ethylene-vinyl acetate, ethylene-acrylate, ethylene-methacrylate, ionomers, fluoropolymers, styrene block copolymers, and polyurethanes.

12. The composite film as claimed in claim 1, wherein the polymer film is a polycaprolactone-based thermoplastic polyurethane.

13. The composite film as claimed in claim 1, wherein the adhesive layer is a pressure-sensitive adhesive layer comprising at least one pressure-sensitive adhesive.

14. The composite film as claimed in claim 1, wherein at least one of the layers comprises a colorantor.

15. The composite film as claimed in claim 1, wherein the coating base comprises exclusively monomers as reactive components, wherein at least one of the monomers having has at least two (meth)acrylate functions, and wherein the coating layer thickness is 2 μm or less.

16. A method of using the composite film as claimed in claim 1 as surface protection film or as decorative film.

17. The composite film as claimed in claim 1, wherein the coating layer at room temperature has a surface hardness of 2.0 to 3 N/mm².

18. The composite film as claimed in claim 1, wherein the coating layer at room temperature has a surface hardness of 2.0 to 2.5 N/mm².

19. The composite film as claimed in claim 1, wherein the polymer film layer at room temperature has a surface hardness of 2.0 to 3 N/mm².

20. The composite film as claimed in claim 1, wherein the polymer film layer at room temperature has a surface hardness of 2.0 to 2.5 N/mm².

21. The composite film of claim 3, wherein the urethane (meth)acrylate is present at a weight fraction of at least 36% of the total amount of compounds having (meth)acrylate or vinyl functions.

22. The composite film of claim 3, wherein the urethane (meth)acrylate is present at a weight fraction of at least 45% of the total amount of compounds having (meth)acrylate or vinyl functions.

23. The composite film as claimed in claim 4, wherein the compound having at least two (meth)acrylate functions is present at a weight fraction of more than 45 wt %.

24. The composite film of claim 8, wherein the compound comprises a morpholine group.

25. The composite film of claim 8, wherein the compound comprises 4-(1-oxo-2-propenyl)morpholine.

26. The composite film of claim 9, wherein the nanoparticles are in the form of inorganic oxides.

27. The composite film of claim 10, wherein the acrylate coating layer has a thickness of 0.5 to 12 μm.

28. The composite film of claim 14, wherein the colorant is present in a further layer.
